(19) United States
(12) Patent Application Publication
(10) Pub. No.: US 2024/0405961 A1
(43) Pub. Date: Dec. 5, 2024

(54) INTERNET-OF-VEHICLES POWER SAVING SCHEMES

(71) Applicant: ZTE Corporation, Shenzhen (CN)

(72) Inventors: Weiqiang DU, Shenzhen (CN); Lin CHEN, Shenzhen (CN); Wei LUO, Shenzhen (CN)

(21) Appl. No.: 18/806,319

(22) Filed: Aug. 15, 2024

Related U.S. Application Data
(63) Continuation of application No. PCT/CN2022/093739, filed on May 19, 2022.

(51) Int. Cl. H04L 5/00; H04W 92/18

(52) U.S. Cl. CPC H04L 5/0098; H04W 92/18

(57) ABSTRACT

Methods, apparatus, systems for implementation of wireless communication techniques using device-to-device communication, e.g., sidelink communication, are described. One example method includes receiving, by a first user device, a carrier aggregation, CA, operation information and operating the first user device according to the CA operation information. The first user device is configured to perform a device-to-device communication using CA with the second user device without relaying through a network device.

### CROSS REFERENCE TO RELATED APPLICATIONS

This patent document is a continuation of and claims benefit of priority to International Patent Application No. PCT/CN2022/093739, filed on May 19, 2022. The entire content of the before-mentioned patent application is incorporated by reference as part of the disclosure of this application.

### TECHNICAL FIELD

This disclosure is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for communicating in an in a sidelink deployment for New Radio (NR).

In one example aspect, a method of wireless communication is disclosed. The method includes receiving, by a first user device, a carrier aggregation, CA, configuration information, wherein the first user device is configured to perform a device-to-device communication using CA with the second user device without relaying through a network device; and operating the first user device according to the CA configuration information.

In another example aspect, a method of wireless communication is disclosed. The method includes transmitting, by a wireless device to a first user device, a carrier aggregation, CA, configuration information, wherein the first user device is configured to perform a device-to-device communication using CA with a second user device without relaying through a network device.

In another example aspect, a method of wireless communication is disclosed. The method includes transmitting, by a first user device, to a second user device, a report request for reporting a channel state, wherein the first user device is configured to perform a device-to-device communication with the second user device using one or more of the N carriers without relaying through a network device, where N is an integer greater than 1.

In another example aspect, a method of wireless communication is disclosed. The method includes receiving, by a second user device, from a second user device, a report request for reporting a channel state, wherein the second user device is configured to perform a device-to-device communication with the first user device using one or more of the N carriers without relaying through a network device, where N is an integer greater than 1; and performing a channel state information (CSI) related operation according to the report request.

In yet another example aspect a wireless communication apparatus is disclosed. The apparatus includes a processor configured to implement a method disclosed in the present document.

In yet another example aspect, a computer-readable medium is disclosed. The medium has processor-executable code stored thereon. The code, upon execution, causes the processor to implement a method disclosed in the present document.

These, and other, aspects are described in the present disclosure.

### BRIEF DESCRIPTION OF DRAWINGS

FIG. 1 shows an example wireless network in which sidelink communication is used.

FIG. 2 shows an example of message exchanges for CA configuration.

FIG. 3 shows an example of rejection of a CA configuration.

FIG. 4 shows an example of implementing a PDCP split or PDCP duplication according to a CA configuration.

FIG. 5 shows an example of performing channel state information (CSI) measurements using a CA configuration.

FIGS. 6A-6D show flowcharts of example wireless communication methods.

FIG. 7 shows an example of a wireless communication network.

FIG. 8 shows an example hardware platform for implementation of a disclosed method.

### DETAILED DESCRIPTION

Headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only and may be used in wireless systems that implemented other protocols. Although some embodiments are described with reference to vehicle based wireless communication functionality, the disclosed techniques may be used by a variety of different wireless device including, e.g., a mobile phone, a tablet, and other wireless devices.

The present document relates to wireless systems. More specifically, it relates to communications between UE for side link communication, and for the scheduling of resources. Parameters are exchanged by one UE to another so that the UE can be configured.

In the current sidelink technical solution, the UE is required to monitor the measurement resource pool, which results in extremely large power consumption. The present invention provides a UE energy saving method suitable for sidelink system.

With the development of wireless multimedia services, user demand for high data rates and user experience are increasing, which puts forward higher requirements on the system capacity and coverage of traditional cellular networks. On the other hand, application scenarios such as public safety, social networking, short-distance data sharing, and local advertising have gradually increased the demand for people to understand and communicate with nearby people or things (Proximity Services). The traditional base station-centric cellular network has obvious limitations in terms of high data rate and proximity service support. Under the background of this demand, the device-to-device D2D (Device-to-Device) communication technology has emerged. The application of D2D technology can reduce the burden on the cellular network, reduce the battery power consumption of user equipment, increase the data rate, and improve the robustness of the network infrastructure, which satisfies the requirements of the aforementioned high data rate services and proximity services. D2D technology is also called Proximity Services (ProSe), unilateral/sidelink/Sidelink (SL) communication; the interface between the device and the device is the PC5 interface.

In the present document, to improve the reliability, data rate, reduce the latency, among other benefits, PC5 Carrier Aggregation (CA) is proposed to achieve high reliability and high data rate. CA denotes that two or more Component Carriers (CCs) are aggregated in order to support wider transmission bandwidths. When it comes to PC5 CA, it means that vehicle UE may simultaneously perform sidelink reception or transmission on one or multiple PC5 CCs. But there has been no existing effective solution to realize data split and/or data duplication based on PC5 CA.

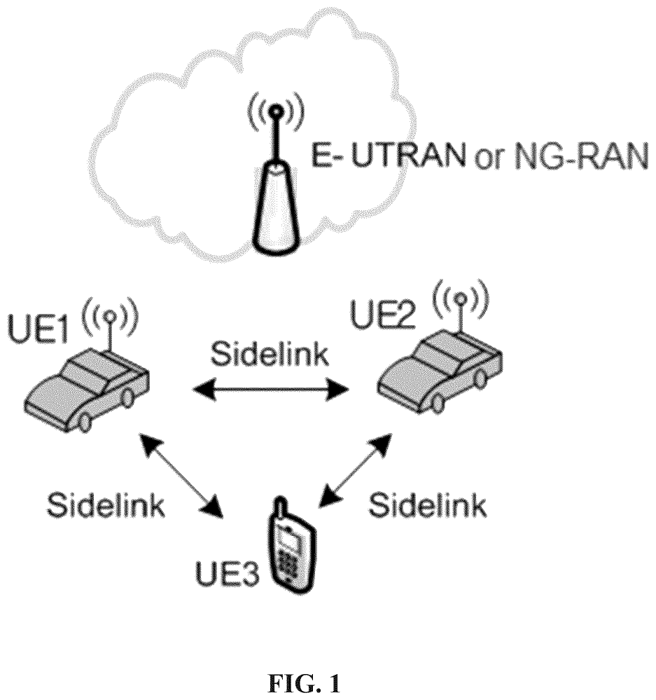

FIG. 1 is a block diagram of an example V2X (vehicle-to-vehicle) communication system. In the LTE (Long Term Evolution)-based V2X communications study organized by the Third Generation Partnership Project 3GPP, user devices (User Equipment UE) may communicate using V2X communication between a direct/sidelink link. For example, data may not be forwarded by the base station and the core network, and may be directly transmitted by the source UE to the target UE through an air interface (PC5 interface), as shown in FIG. 1.

With the advancement of communication technology and the development of the automation industry, the V2X communication scenario is further extended and has higher performance requirements. 3GPP has established research on vehicle networking communication based on advanced V2X services of the fifth-generation mobile communication technology (5G), including 5G air interface-based vehicle networking communication and 5G direct link (sidelink)-based vehicle networking communication. A sidelink communication is an example of a device-to-device communication in which two user devices may communicate with each other via a direct link, without relaying the messages through the network (e.g., a base station).

For NR-based vehicle to everything (V2X) sidelink communications, a PC5 interface Radio Resource Control RRC signaling interaction may be supported. Specifically, PC5 RRC signaling may include a message for transmitting capability of UEs. The present document relates to, among other things, obtaining peer UE's capability information and interacting for PC5 UE capability information exchange for sidelink transmission parameters selection. In addition, PC5 RRC signaling may not be transmitted without security protection, and the present embodiments may provide a security protection mechanism for protecting PC5 RRC signaling at the access-stratum (AS) layer.

In one embodiment, supposing that UE1 transmit data to UE2, due to hidden node problem, UE2 knows which carrier is appropriate to be used for data receiving. Therefore, UE2 can determine the CA configuration for UE1 to transmit the data to UE2.

In another embodiment, in case UE2 is in RRC connected state, it is reasonable for UE2's gNB to determine the CA configuration for UE1 to transmit data to UE2.

In one embodiment, it is also possible that UE1 determines the CA configuration for UE1 to transmit the data to UE2.

In some embodiments, UE1 is in RRC connected, it is reasonable that UE1's gNB wants to determine the CA configuration for UE1 to transmit data to UE2.

In one embodiment, in case that the UE2 or UE2's gNB determines the CA configuration for UE1 to transmit data to UE2, UE2 needs to know the assistance information to determine the CA configuration. Therefore, UE1 may need to send the assistance information for transmission to UE2.

In one embodiment, assistance information is used to determine the CA configuration

In one embodiment, in case that UE2's gNB determines the CA configuration for UE1 to transmit data to UE2, then UE2 need to send the assistance information to gNB.

In one embodiment, in case that the UE1 or UE1's gNB determines the CA configuration for UE1 to transmit data to UE2, then UE2 may need to send the assistance information to UE1.

In case that UE1's gNB determine the CA configuration for transmission of UE1, UE1 may need to send the assistance information for transmission to UE1.

The assistance information can be transmitted via system information, RRC signaling or MAC CE or PHY layer signaling.

The CA configuration can be transmitted via system information, RRC signaling or MAC CE or PHY layer signaling.

### 1. Example Embodiment 1 (CA Assistance Information)

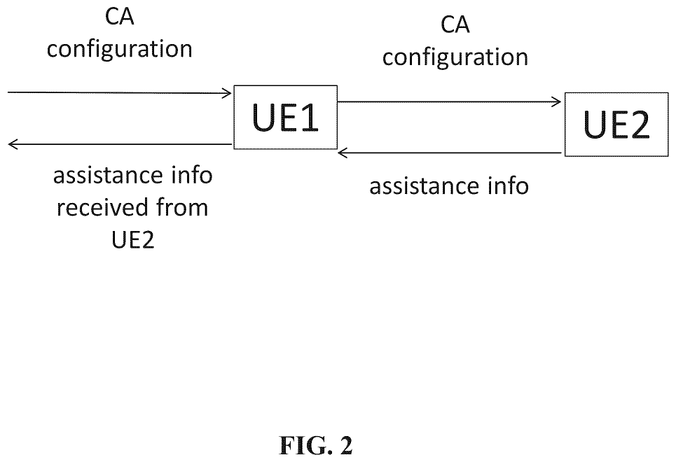

FIG. 2 shows an example configuration in which UE1 and UE2 may exchange assistance information related to carrier aggregation (CA) configuration for establishment or operation of a sidelink using CA.

In some embodiments, based on the carrier configuration like Time Division Duplexing TDD, Frequency Division Duplexing FDD configuration, synchronization configuration, one carrier may not be suitable to or cannot aggregate with another carrier. Therefore, the carriers that can be aggregated with each other may need to be included in the assistance information. Therefore, assistance information includes one or more carrier list indicating the possible carrier combination.

In one embodiment, the carriers in one list can be aggregated with other carrier in same list, the carriers in one list cannot be aggregated with carriers in another list.

In another embodiment, the carrier in one list can be aggregated with other carrier in another list, however the carriers in one list cannot be aggregated with other carrier in same list.

For example, there may be two carrier list: (CC1, CC2) (CC3, CC4, CC5) are sent to UE1 from UE2, CC1 can only be aggregated with CC2, CC1 cannot aggregate with CC3 or 4 or 5, CC3,4,5 can aggregate with each other. Here, “CC” represents a component carrier.

As another example, there may be two carrier list: (CC1, CC2) (CC3, CC4, CC5) are sent to UE1 from UE2, CC1 can only be aggregated with CC3 or 4 or 5, CC1 cannot aggregate with CC2. Here, “CC” represents a component carrier.

In some embodiments, based on UE capability, a UE can only monitor a certain number of carriers simultaneously. Therefore, how many carriers can be used together may be included in the assistance information. For example, UE1 obtains that at most 8 carriers can be used with each other from UE2.

In one embodiment, another information (item) that may be sent to UE2 is the supported carriers, so that UE1 knows which carriers can be used for communication with UE2. Therefore, the supported carriers may need to be included in the assistance information. For example, the assistance information includes 16 carriers supported by peer device.

In some embodiments, based on the channel quality, TX/RX requirements, Uu data requirements or something else, UE may prefer to or not prefer to or cannot transmit/receive the data on a specific carrier. Therefore, the assistance information may include at least one of following:

1. one or more preferred carrier that are preferred to be used for device-to-device communication

2. one or more non-preferred carrier that are not preferred to be used for device-to-device communication

3. one or more prohibited carrier that are prohibited to be used for the device-to-device communication

4. one or more allowed carriers that are allowed to be used for the device-to-device communication

5. one or more carriers.

Various types of carriers may be indicated in the assistance information as follows.

A preferred indicator may indicate whether the corresponding carriers in assistance information is a preferred carrier.

5 A non-preferred indicator may indicate whether the corresponding carriers in assistance information is non preferred carrier.

6. A prohibited carrier indicator may indicate whether the corresponding carriers in assistance information is a banned (or prohibited) carrier

6a. An allowed carrier indicator may indicate whether the corresponding carrier in assistance information is a allowed carrier

7. An object for which the assistance information applied

8. A priority of carrier

9. A priority order of one or more carriers.

In one embodiment, the object can be at least one of following:

1. The LCID (logical ID) of RLC channel

3. The RLC channel ID of RLC channel

4. The RB ID of RB.

5. The carrier.

6. The QoS flow ID of a QoS flow.

10. The destination L2 ID.

11. The QoS profile.

12. The RLC channel configuration index of RLC channel

14. The radio bearer configuration index of a RB.

In one embodiment, the RLC can be a sidelink RLC

In one embodiment, the RB can be a sidelink RB.

In one embodiment, the QoS profile can be sidelink Qos profile

In one embodiment, the QoS flow can be a sidelink QoS flow.

In one embodiment, the status of carrier may have large impact on CA configuration determination. Therefore, assistance information may include the status of each carriers to The status of each carrier includes at least one of following:

1. CBR (channel busy ratio)

2. RSRP (reference signal received power)

3. CSI (Channel state information)

In NR system, different sub-carrier spacing is supported to achieve flexible configuration. If two or more carrier with different sub-carrier spacing are aggregated with each other, UE may need to be configured with slot aggregation. Therefore, the assistance information may include the slot aggregation information The slot aggregation information includes at least one of following:
1. Whether the slot aggregation is supported (per-device, or per-carrier)
2. The sub-carrier spacing of each carrier.
3. The symbol length of each carrier
4. The supported sub-carrier spacing of each carrier.
5. The supported sub-carrier spacing of slot aggregation of each carrier.
6. BWP configuration of each carrier.

In NR V2X system, a specific service may support one or more carrier. UE using one services can only use these configured carriers. However, gNB may not provide configuration for all supported carrier of a specific service. Therefore, if UE can obtain the V2X communication configuration for a specific carrier from gNB or if the UE cannot detect at least one cell on the frequency which UE is configured to perform NR sidelink communication on fulfilling the S criterion, it shall consider itself to be in-coverage on that carrier, otherwise, it shall consider itself to be out-of-coverage. The coverage state of the carrier can be one factor that will be taken into consideration during CA determination. In one embodiment, the assistance information may include coverage state of each supported carrier. The coverage status can be at least one of following: In coverage, out of coverage, partial coverage.

In NR V2X system, the UE may be configured with different resource mode (scheduling or UE selection) of each carrier. Therefore, the assistance information may include the resource mode of each carrier for CA determination.

In the NR sidelink system, in addition to service data, UE may also transmit the synchronization signal and management information block MIB information. However, due to half-duplex issue, UE transmitting the sync signal cannot receive the data simultaneously. Therefore, the assistance information nay includes the synchronization information for UE's CA determination. The synchronization information may include at least one of following:

1. The synchronization signaling resource configuration.

2. synchronization priority, including at least one of gNB is prioritized, GNSS is prioritized, UE is prioritized to be selected as synchronization reference.

3. the number of sidelink synchronization signal block SSB transmissions within one sidelink SSB period

4. whether the UE shall transmit synchronization information

5. The priority of sidelink synchronization signaling

6. the priority of sidelink SSB

7. the allowed synchronization reference(s)

8. Carrier type of each carrier, includes at least one of following: serving carrier/non-serving carrier/sync-carrier/non-sync carrier/uplink carrier/downlink carrier

In one embodiment, after receiving the CA configuration, based on transmission status, UE2 may prefer to deactivate/activate a carrier or packet duplication or packet split. In this case, UE2 can sends the assistance information to UE1 for UE1 or UE1's serving gNB to determine CA configuration. Therefore, the assistance information including at least one of following:

1. CA configuration

2. preferred indicator on whether the corresponding CA configuration is a preferred CA configuration.

3. non-preferred indicator on whether the corresponding CA configuration is a non-preferred CA configuration.

4. prohibit indicator indicating whether the corresponding CA configuration cannot be used.

5. the object for which the assistance information applies

6. a preferred CA configuration.

7. a non-preferred CA configuration.

8. a prohibit CA configuration.

For example, if the assistance information including CA configuration with carrier-1 and preferred indication is received by UE1, UE1 considers that UE2 prefer to use carrier-1 for communication.

For example, if the assistance information including CA configuration with RLC channel ID-1, indication of activating the packet duplication and preferred indication is received by UE1, UE1 considers that UE2 prefer to activate the packet duplication for the RLC channel with ID 1.

In NR V2X system, UE may communicate with other UE and gNB simultaneously. In this case, the CA configuration can be determined by gNB. Therefore, UE should report the received assistance information from other UE listed in this patent to gNB.

### 2. Example Embodiment 2 (CA Configuration Rejection Cause)

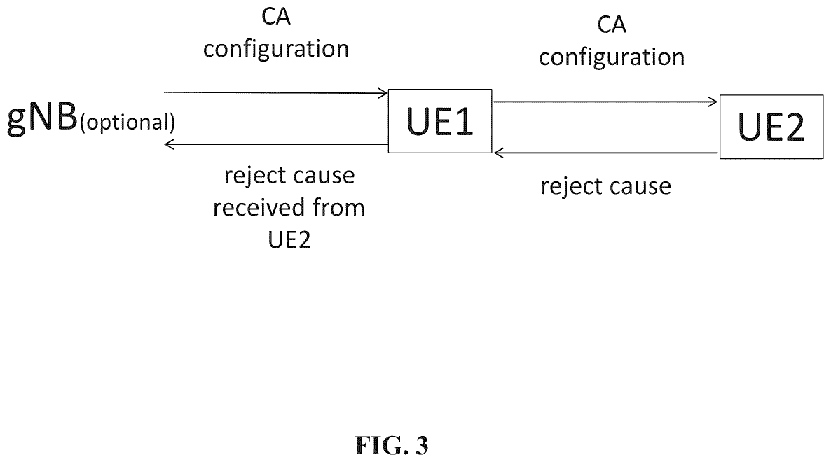

FIG. 3 shows an example of a configuration of wireless devices in which Embodiment 2 may be implemented.

In some cases, the CA configuration from UE1 to UE2 cannot be applied, for example, UE2 may be configured to receives the data on another carrier, the carrier configured by UE1 cannot be used simultaneously. Therefore, UE2 may reject the CA configuration. In this case, the UE2 can send the reject signaling indicating the CA configuration is rejected to UE1.

In case UE1 is in RRC connected mode, it is possible that the CA configuration is configured by gNB, UE1 can send the reject signaling indicating that the CA configuration is rejected by UE2 to gNB. In this case, the reject signaling including the ID of UE2, the ID can be DST L2 ID if UE2.

In one embodiment, to help UE1 identifies the reason why the CA configuration cannot be applied (e.g., why the configuration is rejected by UE2), UE2 can provide some necessary information to UE1, the information includes at least one of following:
1. The CBR (Channel busy ratio) of the configured carrier is higher than a CBR threshold.
2. The carrier is not supported.
3. The carrier is rejected by the serving cell or gNB.
4. The carrier is banned.
5. The number of RLC bearer.
6. The number of logical channel cannot be accepted.
7. The carrier is used for transmission or synchronization signal transmission or uplink transmission or downlink transmission.

In another embodiment, UE2 can also provide the recommended CA configuration to UE1 if the CA configuration from UE1 cannot be applied. the recommended CA configuration is the CA configuration recommended by UE2.

### 3. Example Embodiment 3.1 (CA Configuration)

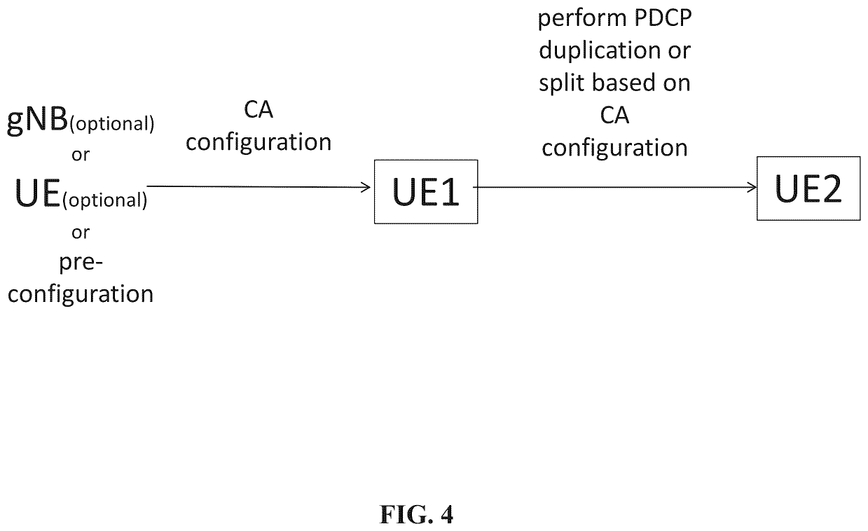

FIG. 4 shows an example configuration of wireless devices in which Embodiments 3.1 and 3.2 may be implemented.

In a legacy NR sidelink system, UE is configured with a mapping rules between the service and one or more carriers (e.g., a carrier list is associated to a service). UE transmitting a service data can only use the carriers in the carrier list associated to the service. For sidelink groupcast and broadcast, since no RRC signaling is supported, TX UE and RX UE cannot exchange carrier capability, TX UE must select carriers associated to a service based on its own capability. For sidelink unicast during link establishment, same issue exits, i.e. TX UE must select carrier associate the service. Therefore, for GC/BC/unicast initial signaling, TX UE considers that all carriers associated to a service will be supported by RX UE. After unicast link establishment, UE can exchange radio resource control RRC signaling with other UE, UE can obtains the carrier capability of peer UE.

In one embodiment, UE can be configured with carrier list associated to one service, the carrier list includes default carriers which are assumed to be supported by peer UE. For example, without peer UE's carrier capability, UE can use these carriers to transmit groupcast/broadcast/unicast initial link establishment signaling to peer UE.

In another embodiment, UE can be configured with carrier list associated to one service, the carrier list includes optional carriers which are supported based on UE capability. For example, after checking peer UE's carrier capability, UE can use the carriers that are supported by peer UE.

In another embodiment, the carrier not included in the carrier list associated to a service can also be used for communication with peer UE after obtaining the supported carrier of peer UE. In further embodiment, UE is configured with whether it is allowed to use the carrier not included in the carrier list associated to a service can be used for communication with peer UE after obtaining the supported carrier of peer UE.

For example, carrier list-1 includes the default carrier list which must be supported by UEs that is interested on this service, carrier list-2 includes optional carriers, to use the carrier listed in list-2, UE1 needs to check whether carriers in list-2 is supported by UE-2, i.e., UE2 provides the supported carrier to UE1. Before establishing the connection with UE2, UE1 cannot obtain the carrier capability of UE2, UE1 can only select the carriers from carrier list-1 to transmit the connection signaling during link establishment, for example, direct communication request signaling, security mode command signaling, security mode complete signaling, direct communication response signaling. After connection establishment, UE1 can obtain the carrier capability of UE2, e.g., which carrier is supported by UE2, then UE1 can use the carriers in list-1 or list-2 supported by UE-2. In another embodiment, only one list is configured, part of carriers in the list can be used by without peer UE's carrier capability, another part of carriers in the list can only be used after checking the UE capability of peer UE.

In one embodiment, the CA configuration includes at least one of following:
1. one or more carriers used for communication.
2. the object for which the CA configuration applies.

For example, in case UE1's gNB determine the CA configuration for UE1 to transmit data to UE2, UE1 receives the CA configuration including carrier 1 and DST L2 ID of UE2, UE1 should use carrier 1 to communicate with DST L2 ID of UE2. Then UE1 inform UE2 that carrier 1 will be used for communication by sending carrier 1 to UE2.

For another example, in case UE2 determine the CA configuration for UE1 to transmit data to UE2, UE1 receives the CA configuration including carrier 1 for communication from UE2, it means UE1 should use carrier-1 to communicate with UE2. In case UE1 is in RRC connected mode, UE1 report the CA configuration including carrier 1 and DST L2 ID of UE2 to gNB.

In one embodiment, the carrier is identified by at least one of: carrier index, frequency of carrier.

In another embodiment, after receiving the carriers used for communication, UE does not need to use all carriers immediately, in other words, these carriers are deactivated or activated. an activation signaling is transmitted to indicates which carrier is activated or deactivated. Therefore, CA configuration includes at least one of following:

1. carrier status indicator. In further embodiment, the carrier status indicator can be at least one of: activate the carrier, or deactivate the carrier

2. The object for which the CA configuration applies.

### 4. Embodiment 3.2 (CA Configuration: Packet Split and Duplication Configuration)

The benefits of CA is to perform data split or duplication to improve the data rate or reliability. For data duplication, the TX UE may transmit duplicated sidelink packet on multiple carriers. RX UE may detect the duplication and discard the duplicated packet. In one embodiment, the packet duplication can be at least one of: PDCP duplication, or MAC duplication.

For the packet split, the parallel transmission of different packet packets on multiple carriers may be considered. Since the radio resources of multiple carriers could be used for a transmission (Tx) UE, the data rate of sidelink transmission can be improved. On the other hand, to support the packet split, simultaneous reception over multiple carriers may be supported from the perspective of the receiving (Rx) UE. In one embodiment, the packet split is at least one of: PDCP split, or MAC split.

For the radio bearer (RB) that configured with PDCP duplication, the PDCP entity duplicates the PDCP PDU and delivers the packet to two or more different RLC entities. For the PDCP data split, the PDCP entity may deliver the PDCP PDUs to different RLC entities according to pre-configured rules.

Packet duplication and split are two standalone functions and can be configured and/or used separately.

In one embodiment, the CA configuration may include at least one of following:

1. a configuration of transmission scheme

2. the object for which the CA configuration applies

In one embodiment, the transmission scheme can be at least one of following:

1. the packet duplication.

2. the packet split.

In one embodiment, to perform packet duplication or packet split, CA configuration includes at least one of following:

1. PDCP configuration associated to one or more RLC channel.

2. the object for which the CA configuration applies.

In one embodiment, in case one PDCP entity is associated to more than one RLC channel, not all RLC channel is activated for the associated PDCP entity, therefore the CA configuration includes at least one of following:

1. RLC channel status. In further embodiment, the RLC channel status indicator includes at least one of following: activate the RLC cannel, or deactivate the RLC channel.

2. The object for which the CA configuration applies.

In one embodiment, the RLC channel status can be at least one of activated or deactivated.

For example, if the RLC channel is deactivated, UE cannot submit the packet to deactivated RLC channel. Or if the RLC channel is deactivated for PDCP duplication, the UE cannot submit the duplicated packet to this RLC channel. Or if the RLC channel is deactivated for PDCP split, the UE cannot submit the packet to this RLC channel. In one embodiment, not all PDCP associated with more than one RLC channel can use the transmission scheme, corresponding scheme can be further activated or deactivated for one RLC channel. If the PDCP duplication is activated for a PDCP entity, then UE can duplicate the packet and submit the duplicated packet to more than one RLC channel. If the PDCP split is activated for a PDCP entity, then UE can submit the packet to more than one RLC channel.

In one embodiment, the transmission scheme is not used immediately after receiving transmission scheme configuration. In other words, when UE receives the CA configuration, transmission scheme may be deactivated or activated, UE1 can activate or deactivate transmission scheme correspondingly based on some pre-defined condition or CA configuration. Therefore, the CA configuration received by UE including:

1. transmission scheme status indicator. In further embodiment, transmission scheme status indicator. can be at least one of following: (1). activate the packet duplication (2) deactivate the packet duplication (3). activate the packet split (4). deactivate the packet split

2. The object for which the CA configuration applies.

In one embodiment, if PQI and packet transmission status is included in the CA configuration, the packet transmission is applied on the RB having QoS flow with this PQI.

In one embodiment, if QoS profile and packet transmission status is included in the CA configuration, the packet transmission is applied on the RB having QoS flow with this QoS profile.

For example, UE1 receives the CA configuration including activate the packet duplication, and LCID 1 from UE2 having DST L2 ID 1, then UE1 should activate the packet duplication for RLC channel with LCID 1. And if UE1 is in RRC connected mode, UE1 should send the CA configuration including packet duplication activation, LCID 1 and DST L2 ID 1 to gNB.

For example, UE1 receives the CA configuration including activate the packet duplication, and LCID 1, DST L2 ID 1 from gNB, then UE1 should activate the packet duplication of RLC channel with LCID 1 for peer UE with DST L2 ID 1. And then UE1 send the CA configuration including activate the packet duplication, and LCID 1 to UE2 with DST L2 ID 1 to inform UE2 the activation of packet duplication.

In NR system, for a specific radio bearer, one parameters of PDCP security is logical channel identifier (LCID). When transmission scheme is configured, more than one RLC channel with different LCID will be associated to one PDCP entity. Therefore, UE needs to know which LCID will be used as parameters of PDCP security. In one embodiment, at least one of following ID will be used to determine the parameters of PDCP security:

1. the LCID of primary RLC channel used for PDCP security.

2. the LCID of first RLC bearer within RLC bearer list associated to same RB will be used for PDCP security

3. Instead of LCID, radio bearer ID will be used for PDCP security.

4. Instead of LCID, radio bearer configuration index will be used for PDCP security.

In one embodiment, UE receives at least one of following configuration to determine the parameters of PDCP security:

1. RLC bearer configuration includes an indicator on whether the LCID of this RLC channel will be used for PDCP security.

2. an indicator on which LCID will be used for PDCP security for a specific RB. In one embodiment, The indicator can be at least one of: LCID, RLC bearer ID, RLC configuration index, RLC channel ID.

To determine whether the transmission scheme should be enabled, at least one of following can be applied on UE:

1. UE is configured with an CA configuration including MFBR (maximum flow bitrate) or GFBR (guaranteed flow bitrate) threshold. In further embodiment, if the MFBR or GFBR of at least one QoS flows associated to specific RB (radio bearer) is higher than the MFBR or GFBR threshold correspondingly, the UE should enable the transmission scheme for this specific RB. In another embodiment, the sum of MFBR or GFBR of all GBR QoS flows associated to a RB may be is higher than a threshold, UE shall enable transmission scheme.

2. UE is configured with a CA configuration including AMBR (Aggregate maximum bitrate) threshold. In sidelink, AMBR limits the aggregate bit rate that can be expected to be provided across all Non-GBR QoS Flows with a peer UE over PC5 unicast link. In one embodiment, if the AMBR of all non-GBR QoS flows associated to a specific destination is higher than the threshold, UE should enable transmission scheme for the RB associated to this destination.

3. UE is configured with a CA configuration including a data split threshold. In one embodiment, if the total amount of data volume pending for transmission is equal to or larger than the configured threshold, UE should enable transmission scheme. UE can also be configured more than one data split threshold, if the total amount of data volume pending for transmission is equal to or larger than the first threshold, UE can submit the PDU to first split RLC channel, and if the corresponding volume is higher than the second threshold, UE can submit the PDU to either first or second split RLC channel, and so on. For example, UE is configured with a data split threshold list [100, 200, 300], if the pending data volume is less than 100, UE should submit the packet to first RLC channel. if the pending data volume is greater than 100 and less than 200, UE should submit the packet to either first or second RLC channel, if the pending data volume is greater than 200 and less than 300, UE should submit the packet to either first or second RLC channel or third RLC channel,

4. Since PQI identifies a set QoS parameters of a QoS flow, the QoS parameters includes the priority, reliability, Maximum Data Burst Volume, etc., UE can enable transmission scheme according to the PQI of QoS flow. CA configuration includes a specific PQI (PC5 5G quality of service identifier) or PQI list for enable transmission scheme. In other words, the configuration of transmission scheme is enabled per PQI

If the PQI of at least one QoS flows associated to a specific RB is configured to enable transmission scheme, UE enables transmission scheme for this specific RB. In another embodiment, UE should only enable transmission scheme for the PDU belonging to the QoS flow with PQI equal to the configured PQI.

For example, UE is configured with PQI list [1, 2, 3] to enable PDCP duplication, then UE should enable PDCP duplication for RB with at least one QoS flow having PQI 1 or 2 or 3

UE's QoS parameters can use non-standard parameters (e.g., not identified by a PQI), these QoS parameters are included in the QoS profile. Therefore, UE can enable the transmission scheme according to the QoS profile. The QoS profile includes an indication on whether UE should enable transmission scheme for the QoS flow having this QoS profile.

If QoS profile of at least one QoS flow associated to an RB includes this indication, UE should enable transmission scheme for this RB. In further embodiment, in this case, UE should only enable transmission scheme for the PDU belonging to the QoS flow associated with the QoS profile including the mentioned indication.

5. RSRP (Reference Signal Received Power) threshold: In one embodiment, if the RSRP of communication carrier is lower than the configured RSRP threshold, UE should enable transmission scheme for the RB allowed on this communication carrier. In another embodiment, if the RSRP of all allowed communication carrier associated to an RB is lower than the configured RSRP threshold, UE should enable transmission scheme for this RB.

6. UE is configured with a packet error rate (PER) threshold: If the PER of at least one QoS flow associated to a RB is lower than the configured PER threshold, UE should enabled the transmission scheme for this RB. In another embodiment, UE should only duplicate the PDU belonging to the QoS flow with PER lower than the configured threshold. UE can also be configured with a list of PER threshold. If the PER of at least one QoS flow associated to a RB is lower than the first PER threshold, UE shall submit the duplicated PDU to first duplicated RLC channel, and if it lower than the second PER threshold, UE shall submit the duplicated PDU to first and second duplicated RLC channel, and so on. For example, one PDCP entity is associated to three RLC channel for duplication, two of them are used when duplication is enabled. UE is configured with a list of PER threshold: [10⁻¹, 10⁻², 10⁻³], if the PER of QoS flow is lower than 10⁻¹. then UE should only duplicate the PDCP PDU and submit the duplicated PDU to the first and second RLC channel. If the PER of QoS flow is lower than 10⁻². then UE should only duplicate the PDCP PDU and submit the duplicated PDU to the first, second, and third RLC channel.

1. A threshold: The number of consecutive DTX or NACK shows the reliability of transmission cannot been ensured, UE should enable the transmission scheme to ensure the reliability. In one embodiment if the number of consecutive Discontinuous Reception (DRX) is higher than the threshold, UE should enable transmission scheme. In one embodiment if the number of consecutive NACK is higher than the threshold, UE should enable transmission scheme. In one embodiment if the number of consecutive NACK and DTX is higher than the threshold, UE should enable transmission scheme.

2. A ratio threshold: For groupcast, TX UE can receives the HARQ feedback from more than one RX UEs, therefore, in case if the ratio of the number of Discontinuous Transmission DTX and the expected number of Hybrid Automatic Repeat Request HARQ feedback is higher than a threshold, it means the reliability cannot be ensured, and UE should enable transmission scheme to improve the reliability. In one embodiment, if the ratio of the number of Discontinuous Transmission DTX and the expected number of Hybrid Automatic Repeat Request HARQ feedback is higher than a configured threshold, UE should enable transmission scheme. In another embodiment, if the ratio of the number of DTX and the expected number of HARQ feedback is higher than a the threshold, UE should enable transmission scheme.

3. Two threshold A and B: In one embodiment, UE first calculate the ratio of the number of DTX and the expected number of HARQ feedback, if the number of the ratio higher than the threshold A is higher than the threshold B, UE should enable packet duplication.

4. CA configuration includes whether transmission scheme is activated for SL SRB.

In some cases, considering QoS flow can only be mapped data radio bearer DRB, the QoS related metric cannot be applied on determination of SL SRB. For signaling radio bearer (SRB), UE can be configured with CA configuration including whether transmission scheme should be enabled for SL SRB.

The preferred configuration only shows the preference of UE2, whether the configuration is applied depends on UE1 or UE1's gNB's decision.

### 5. Embodiment 4 (CSI Report for CA)

In a legacy NR sidelink, where only one carrier is supported, UE can send a CSI request to peer UE to obtain the CSI report, UE does not need to identify which carrier should be measured. However, if CA is used, if UE receives the CSI request from one carrier, it should identify which carrier needs to be measured, and which carrier is used to send the CSI report.

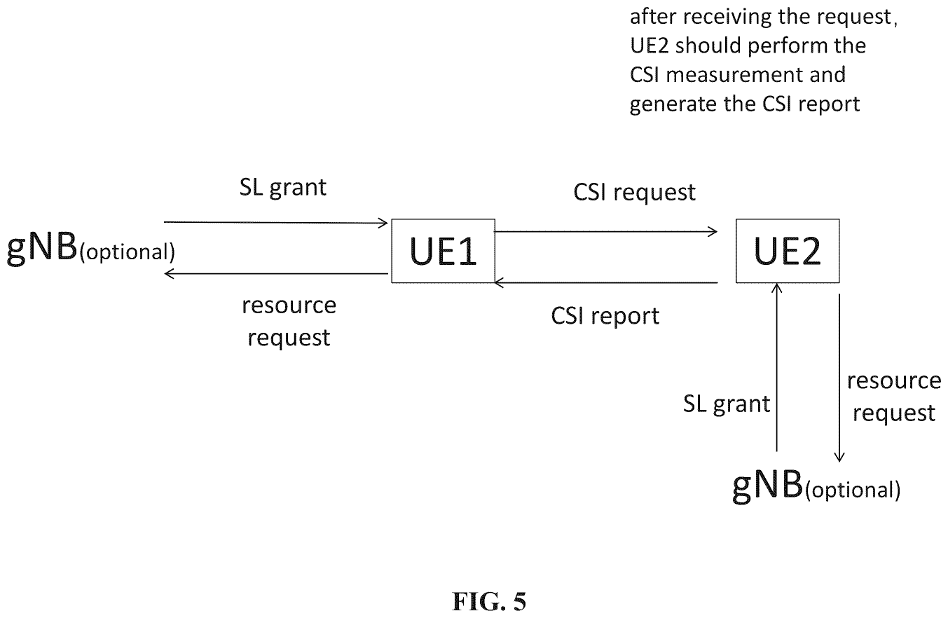

FIG. 5 shows an example of a wireless system configuration in which CSI reporting of CA may be performed in a sidelink configuration.

### 6. Carrier for CSI Request Examples

In one embodiment, if UE want to obtain a CSI report of one carrier, UE should send the CSI request on this carrier. For example, UE wants to obtain the CSI of carrier-1, then UE should also transmit the CSI request on carrier-1.

### 7. CSI Measurement Examples

In one embodiment, the carrier of which the UE measures the CSI is the carrier where the CSI request is received. For example, if UE receives the CSI request from carrier-1, then UE should also measure the CSI of carrier-1.

In one embodiment, UE should measure CSI of all carriers after receiving the CSI request.

In one embodiment, CSI request includes an indicator on which carrier should be measured. The CSI request includes at least one of following:
1. carrier
2. BWP
3. resource pool

In one embodiment, the carrier is identified by at least one of following: carrier ID carrier index, carrier frequency.

In one embodiment, the resource pool is identified by at least one of following: resource pool ID, resource pool index.

In one embodiment, the BWP is identified by at least one of following: BWP ID

For example, if the CSI request includes carrier ID, the carrier measured by RX UE is the carrier identified by carrier ID.

If the CSI request includes resource pool index or resource pool ID, the carrier measured by RX UE is the carrier including the resource pool identified by resource pool index or resource pool ID.

If the CSI request includes BWP ID, the carrier measured by RX UE is the carrier including the BWP identified by BWP ID.

### 8. CSI Report Examples

In one embodiment, when UE send the CSI request in one carrier, to help UE to differentiate the received CSI belongs to which carrier, before the latency bound of CSI report expires, UE should not trigger the CSI report in another carrier.

In one embodiment, for UE receiving the CSI report, the CSI included in received CSI report is the CSI of the carrier where the CSI report is received.

In another embodiment, for UE receiving the CSI report to identify the received CSI report belongs to which carrier, the CSI report includes at least one of following:
1. carrier
2. BWP
3. resource pool

In this case, if the CSI report includes carrier ID, the CSI report belongs to the carrier identified by carrier ID.

In this case, if the CSI report includes resource pool ID, the CSI report belongs to the carrier including resource pool identified by resource pool ID.

If the CSI report includes BWP ID, the carrier of CSI report is the carrier including the BWP identified by BWP ID.

In one embodiment, UE transmit the CSI report on the carrier where the CSI request is received. For example, UE receives the CSI request from carrier-1, then UE should also transmit the CSI report on carrier-1.

In one embodiment, UE should transmit the CSI report one the carrier where the CSI is measured. For example, UE measure the CSI of carrier-1, then UE should also transmit the CSI report on carrier-1.

### 9. Additional Embodiments (Example Use Cases)

One use case can be:

Example1:

TX UE, and RX UE is in RRC Connected mode.

Step1: TX UE receives the CA configuration including the preferred carriers from RX UE

Step2: TX UE report the CA configuration the preferred carriers and DST L2 ID of RX UE received from RX UE to gNB.

Step3: TX UE receives the CA configuration including carrier used for communication and PDCP duplication configuration from TX UE's gNB.

Step4: TX UE sends the received CA configuration including carrier used for communication and PDCP duplication to RX UE.

Step5: RX UE reports the received CA configuration including carrier used for communication and PDCP duplication to RX UE's gNB.

Step6: TX UE's gNB sends an CA configuration to TX UE to activate a carrier-1, activate the RB-1's PDCP duplication, i.e. the CA configuration including: activate indication, carrier 1, DST L2 ID of RX UE, activate duplication indication, RB1. Then TX UE cannot use carrier-1, and can use PDCP duplication for RB-1.

Step7: TX UE sends the CA configuration including: activate indication, carrier 1 to RX UE. Then RX UE does not need to monitor carrier-1 for reception data from TX UE.

Step8: RX UE report the two indications to RX UE's gNB.

Example:

Example-1 assumes that TX UE is responsible for setting CA configuration (i.e. UE1 is TX UE, UE2 is RX UE), However, caused by hidden node problem, RX UE can obtain more accurate transmission status. Therefore, RX UE can be responsible for setting CA configuration (i.e. UE1 is RX UE, UE2 is TX UE). This examples shows how RX UE sets the CA configuration.

Step1: RX UE sends the activation of PDCP duplication of RB-1 and activation of one carrier-1 to TX UE.

Step2: TX UE should active the RB-1's PDCP duplication and use carrier-1 for communication.

The following listing discloses technical solutions implemented by some preferred embodiments.

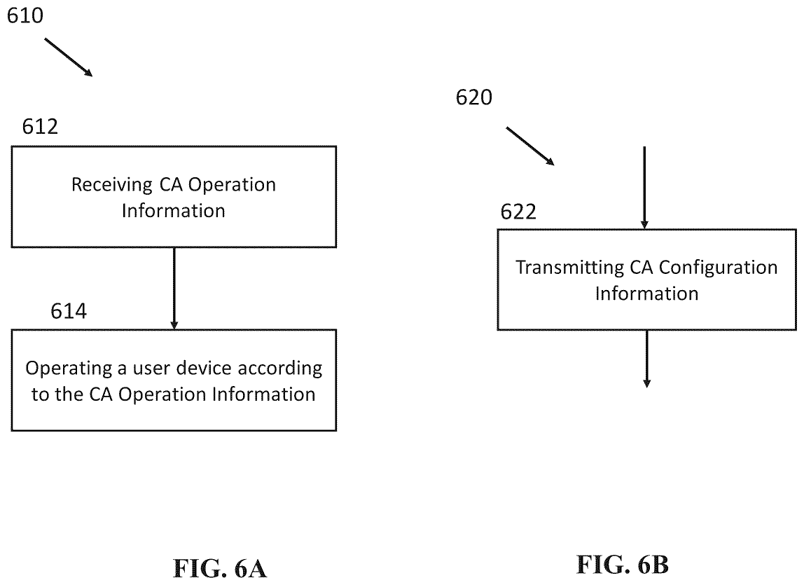

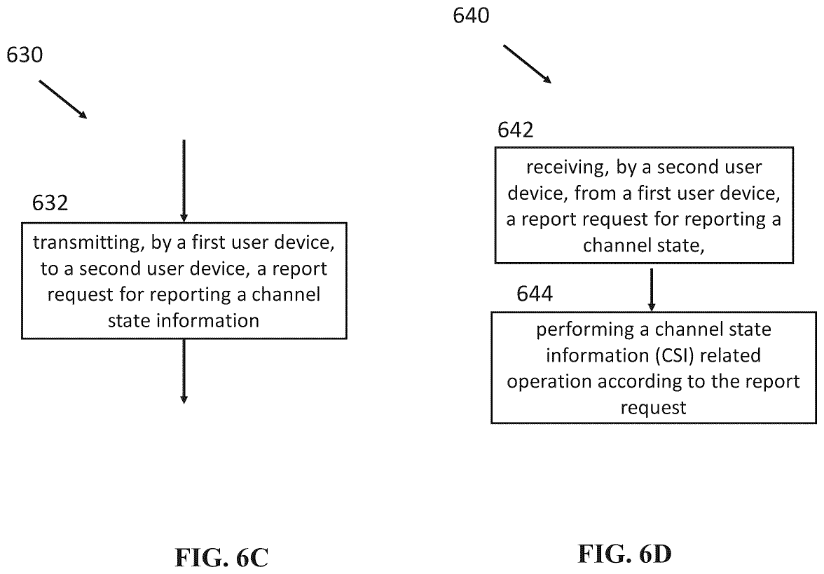

1. A method of wireless communication (e.g., method 610 depicted in FIG. 6A), comprising: receiving (612), by a first user device, a carrier aggregation, CA, operation information, wherein the first user device is configured to perform a device-to-device communication using CA with the second user device without relaying through a network device; and operating (614) the first user device according to the CA operation information. Various examples of CA operation information are disclosed in the present document, e.g., Section 1, which describes CA assistance information, and Section 3, which describes CA configuration information.

2. The method of solution 1, wherein the CA operation information is received from the second user device.

3. The method of solution 1, wherein the CA operation information is received from the network device.

4. The method of solutions 1 or 2, wherein the first use device reports the received CA operation information to network.

5. The method of any of solutions 1-4, wherein the CA operation information comprises CA assistance information including at least one of following: one or more preferred carriers that are preferred to be used for device-to-device communication, or one or more non-preferred carriers that are not preferred to be used for device-to-device communication, or one or more prohibited carriers that should not to be used for the device-to-device communication, or one or more allowed carriers that can be used for the device-to-device communication, a preferred indicator on whether the corresponding carriers in assistance information is a preferred carrier, or a non-preferred indicator on whether the corresponding carriers in assistance information is a non-preferred carrier, or a prohibited carrier indicator on whether the corresponding carriers in assistance information is a banned carrier, or an allowed carrier indicator on whether the corresponding carrier in assistance information is an allowed carrier, or the object for which the assistance information applied, or the priority of carrier, or the priority order of one or more carriers.

6. The method of any of solutions 1-4, wherein the CA operation information comprises CA assistance information that indicates a slot aggregation related information.

7. The method of solution 6, wherein the slot aggregation related information includes at least one or more of:

whether an aggregation of slots is supported by the second user device,

a subcarrier spacing for each of the N carriers,

a symbol length for each of the N carriers,

a subcarrier spacing supported for each of the N carriers,

a subcarrier spacing supported for slot aggregation on each of the N carriers, or

a bandwidth part, BWP, configuration for each of the N carriers.

8. The method of any of solutions 1-4, wherein the CA operation information comprises CA assistance information that includes a coverage state of each of the N carriers.

9. The method of any of solutions 1-4, wherein the CA operation information includes CA assistance information that comprises a resource mode for each of the N carriers.

10. The method of any of solutions 1-4, wherein the CA operation information includes CA assistance information that comprises synchronization information.

11. The method of any of solutions 1-4, wherein the CA operation information includes CA assistance information that includes at least one of following: a CA configuration, a preferred indication on whether the corresponding CA configuration is a preferred CA configuration, a non-preferred indication indicating whether a corresponding CA configuration is a non-preferred CA configuration, a prohibit indication indicating whether the corresponding CA configuration cannot be used, an object for which the assistance information applies, a preferred CA configuration, a non-preferred CA configuration, or a prohibited CA configuration.

12. The method of any of solutions 1-4, wherein the CA operation information includes CA assistance information that includes the synchronization information, and the synchronization information includes one or more of: synchronization signaling resource configuration of each of the N carriers, priority information for synchronization signaling in the device-to-device communication, priority information about synchronization signal block transmission in the device-to-device communication, allowed synchronization reference(s); or a carrier type of each carrier.

13. The method of any of solutions 1-12, wherein the operating the first user device comprises: transmitting, to a source device of the CA operation information, a rejection message that rejects the CA operation information.

14. The method of solution 13, wherein the rejection message indicates a rejection cause.

15. The method of any of solutions 13-14, wherein the rejection message indicates a recommended CA configuration.

16. The method of any of solutions 1-4, wherein the CA operation information comprises CA configuration information that includes one or more mapping rules between services and carriers.

17. The method of solution 16, the mapping rules is that one service is associated to a carrier list including one or more carriers.

18. The method of solution 17, wherein the carrier list includes default carriers which are assumed to be supported by peer device.

19. The method of solution 17, wherein the carrier list includes optional carriers which are supported based on device capability.

20. The method of any of solutions 1-4, wherein the CA operation information comprises CA configuration information.

21. The method of any of solutions 11-20, wherein the CA configuration information indicates at least one of following: an object to which the CA configuration information applies, a configuration of a transmission scheme, a carrier status indicator, an RLC channel status indicator, a transmission scheme status indicator, or one or more carriers used for the device-to-device communication.

22. The method of solution 21, wherein the carrier status indicator indicates one of: the carrier is activated or the carrier is deactivated.

23. The method of solution 21, wherein the RLC channel status indicator indicates at least one of following: activate the RLC channel or deactivate the RLC channel.

24. The method of solution 21, wherein the transmission scheme status indicator indicates at least one of following: packet duplication is activated, packet duplication is deactivated, packet split is activated, or packet split is deactivated.

25. The method of solution 21, wherein the transmission scheme is at least one of following: a packet duplication scheme or a packet split scheme.

26. The method of solution 24, wherein the packet duplication is at least one of a packet data convergence protocol PDCP duplication or medium access control MAC duplication.

27. The method of solution 24, wherein the packet split is at least one of a packet data convergence protocol PDCP split or a medium access control MAC split.

28. The method of solution 21, wherein the transmission scheme is enabled based on a condition, wherein the condition includes one or more of: a maximum flow bitrate (MFBR) threshold, a guaranteed flow bitrate (GFBR) threshold, or an aggregate maximum bitrate (AMBR) threshold.

Additional details of solutions 1-28 are disclosed in Sections 1 to 9 of the present document.

29. A method of wireless communication (e.g., method 620 depicted in FIG. 6B), comprising: transmitting (622), by a wireless device to a first user device, a carrier aggregation, CA, configuration information, wherein the first user device is configured to perform a device-to-device communication using CA with a second user device without relaying through a network device.

30. The method of solution 29, wherein the wireless device is a second user device.

31. The method of solution 29, wherein the wireless device is a network device.

32. The method of any of solutions 29-31, wherein the CA configuration information indicates a preferred carrier.

33. The method of any of solutions 29-31, wherein the CA configuration information indicates a non-preferred carrier or a banned carrier that is not to be used for the device-to-device communication.

34. The method of any of solutions 29-33, wherein the CA configuration information indicates a slot aggregation related information.

35. The method of solution 34, wherein the slot aggregation related information includes one or more of: whether an aggregation of slots is supported by the second user device, a subcarrier spacing for each of the N carriers, a symbol length for each of the N carriers, a subcarrier spacing supported for each of the N carriers, a subcarrier spacing supported for slot aggregation on each of the N carriers, or a bandwidth part, BWP, configuration for each of the N carriers.

36. The method of any of solutions 29-35, wherein the CA configuration information comprises a coverage state of each of the N carriers.

37. The method of any of solutions 29-35, wherein the CA configuration information comprises a resource mode for each of the N carriers.

38. The method of any of solutions 29-37, wherein the CA configuration information comprises synchronization information.

39. The method of solution 38, wherein the synchronization information includes one or more of: synchronization signaling resource configuration of each of the N carriers, priority information for synchronization signaling in the device-to-device communication, or priority information about synchronization signal block transmission in the device-to-device communication.

40. The method of any of solutions 29-39, wherein the operating the wireless device comprises: transmitting, to a source device of the CA configuration information, a rejection message that rejects the CA configuration information.

41. The method of solution 40, wherein the rejection message indicates a rejection condition.

42. The method of any of solutions 40-41, wherein the first user device further indicates a recommended CA configuration.

43. The method of any of solutions 29-42, wherein the CA configuration information includes two mapping rules between services and carriers.

44. The method of solution 43, wherein one of the mapping rules is mandatory and the other mapping rule is optional.

45. The method of any of solutions 29-44, wherein the CA configuration information includes a split or duplication configuration at a packet data convergence protocol, PDCP, layer, wherein the split or duplication configuration identifies a radio link control (RLC) channel or a logical channel identifier (ID) that is used to secure packet data.

46. The method of solution 45, wherein the duplication or split operation is selectively performed based on a condition, wherein the condition includes one or more of: a maximum flow bitrate (MFBR) threshold, a guaranteed flow bitrate (GFBR) threshold, an aggregate maximum bitrate (AMBR) threshold.

Additional details of solutions 129-46 are disclosed in Sections 1 to 9 of the present document.

47. A method of wireless communication (e.g., method 630 depicted in FIG. 6C), comprising: transmitting (632), by a first user device, to a second user device, a request for reporting a channel state information (CSI), wherein the first user device is configured to perform a device-to-device communication with the second user device using one or more of the N carriers without relaying through a network device, where N is an integer greater than 1.

48. The method of solution 47, wherein the request identifies carriers from N carriers for which the channel state is to be reported.

49. The method of solution 47, wherein the request includes at least one of following: a carrier, a bandwidth part BWP or a resource pool.

50. A method of wireless communication, comprising: receiving, by a first user device, from the second user device using the device-to-device communication, a channel state report including channel state information (CSI), wherein the first user device is configured to perform a device-to-device communication with the second user device using one or more of the N carriers without relaying through a network device, where N is an integer greater than 1.

51. The method of solution 50, wherein the channel state report includes at least one of a carrier, a bandwidth part BWP or a resource pool.

52. The method of solution 49 or 51, wherein the carrier is identified by at least one of following: carrier ID, carrier index, carrier frequency.

53. The method of solution 49 or 51, wherein the resource pool is identified by at least one of following: a resource pool ID or a resource pool index.

54. The method of solution 49 or 51, wherein the BWP is identified by a BWP ID.

55. The method of solution 50, where in the first user device considers the CSI included in received CSI report is the CSI of the carrier where the CSI report is received.

56. A method of wireless communication (e.g., method 640 depicted in FIG. 6D), comprising: receiving (642), by a second user device, from a first user device, a report request for reporting a channel state, wherein the second user device is configured to perform a device-to-device communication with the first user device using one or more of the N carriers without relaying through a network device, where N is an integer greater than 1; and performing (644) a channel state information (CSI) related operation according to the report request.

57. The method of solution 56, wherein the report request identifies carriers from N carriers for which the channel state is to be reported.

58. The method of any of solutions 56-57, wherein the CSI operation includes: transmitting, by the second user device using the device-to-device communication, a channel state report including channel state reports for each of the N carriers.

59. The method of any of solutions 56-57, wherein the CSI operation includes: transmitting, from the second user device using the device-to-device communication, channel state reports for requested carriers in separate channel state report messages.

60. The method of any of solutions 56-59, further including: receiving, by the second user device from the first user device, the report request on a carrier that is pre-configured for transmission of the report request.

61. The method of any of solutions 56-60, further including: receiving, by the second user device from the first user device, a carrier to be used for transmission of channel state reports.

62. The method of any of solutions 56-61, further including: receiving, by the second user device from the first user device, a measurement carrier on which a channel state measurement is performed.

Further examples of CSI reporting, measurements and carriers used for CSI are disclosed in Sections 5 to 8 of the present document.

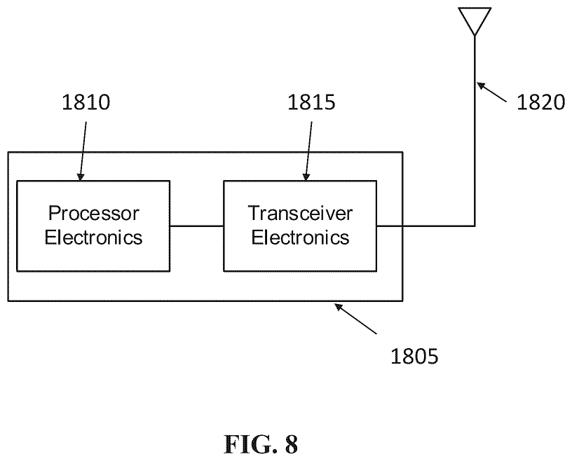

63. An apparatus of wireless communication comprising a processor, wherein the processor is configured to implement a method as recited in the solutions above. The apparatus may be implemented using hardware platform described with respect to FIG. 8.

64. A computer-readable medium having processor-executable code stored thereupon, the code, upon execution by a processor, causing the processor to implement a method as recited above.

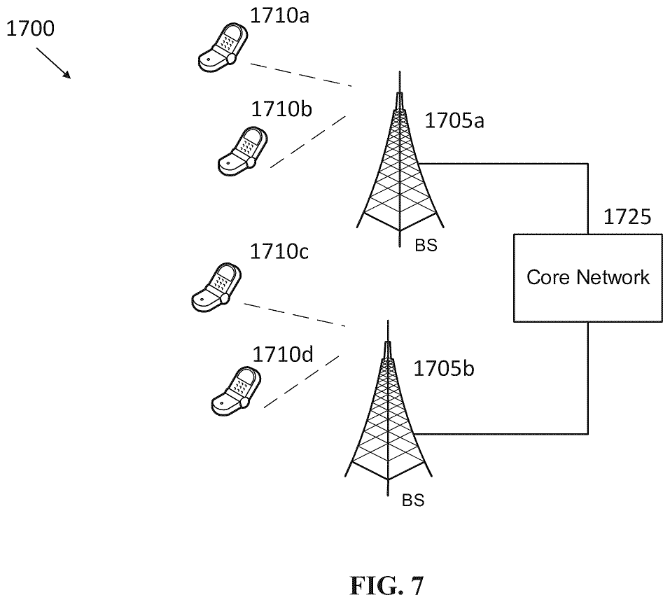

FIG. 7 shows an example of a wireless communication system 1700 where techniques in accordance with one or more embodiments of the present technology can be applied. A wireless communication system 1700 can include one or more base stations (BSs) 1705a, 1705b, one or more wireless devices 1710a, 1710b, 1710c, 1710d, and a core network 1725. A base station 1705a, 1705b can provide wireless service to wireless devices 1710a, 1710b, 1710c and 1710d in one or more wireless sectors. In some implementations, a base station 1705a, 1705b includes directional antennas to produce two or more directional beams to provide wireless coverage in different sectors.

The core network 1725 can communicate with one or more base stations 1405a, 1705b. The core network 1725 provides connectivity with other wireless communication systems and wired communication systems. The core network may include one or more service subscription databases to store information related to the subscribed wireless devices 1710a, 1710b, 1710c, and 1710d. A first base station 1705a can provide wireless service based on a first radio access technology, whereas a second base station 1705b can provide wireless service based on a second radio access technology. The base stations 1705a and 1705b may be co-located or may be separately installed in the field according to the deployment scenario. The wireless devices 1710a, 1710b, 1710c, and 1710d can support multiple different radio access technologies. The techniques and embodiments described in the present document may be implemented by the base stations of wireless devices described in the present document.

FIG. 8 is a block diagram representation of a portion of a radio station in accordance with one or more embodiments of the present technology can be applied. A radio station 1805 such as a base station or a wireless device (or UE), e.g., the various enumerated wireless devices described in the present document, can include processor electronics 1810 such as a microprocessor that implements one or more of the wireless techniques presented in this document. The radio station 1805 can include transceiver electronics 1815 to send and/or receive wireless signals over one or more communication interfaces such as antenna 1820. The radio station 1805 can include other communication interfaces for transmitting and receiving data. Radio station 1805 can include one or more memories (not explicitly shown) configured to store information such as data and/or instructions. In some implementations, the processor electronics 1810 can include at least a portion of the transceiver electronics 1815. In some embodiments, at least some of the disclosed techniques, modules or functions are implemented using the radio station 1805. In some embodiments, the radio station 1805 may be configured to perform the methods described herein.

It will be appreciated that the present document discloses techniques that can benefit various embodiments to perform sidelink communication using carrier aggregation. In one advantageous aspect, the disclosed techniques may be used to reduce power consumption of user devices.

It will be appreciated that the present document discloses techniques that can be embodied in various embodiments and configurations. It should be understood that concepts from some embodiments can be used for other embodiments. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

1. A method of wireless communication, comprising:
receiving, by a first user device, a carrier aggregation (CA) operation information, wherein the first user device is configured to perform a device-to-device communication using CA with a second user device without relaying through a network device; and
operating the first user device according to the CA operation information.

2. The method of claim 1, wherein the CA operation information comprises CA assistance information that includes a coverage state of each of N carriers.

3. The method of claim 1, wherein the CA operation information includes CA assistance information that comprises a resource mode for each of N carriers.

4. The method of claim 1, wherein the CA operation information comprises CA configuration information that includes one or more mapping rules between services and carriers.

5. The method of claim 4, the mapping rules is that one service is associated to a carrier list including one or more carriers.

6. The method of claim 5, wherein the carrier list includes default carriers which are assumed to be supported by peer device.

7. The method of claim 5, wherein the carrier list includes optional carriers which are supported based on device capability.

8. The method of claim 1, wherein the CA operation information comprises CA configuration information.

9. A method of wireless communication, comprising:
transmitting, by a wireless device to a first user device, a carrier aggregation (CA) configuration information, wherein the first user device is configured to perform a device-to-device communication using CA with a second user device without relaying through a network device.

10. The method of claim 9, wherein the CA configuration information comprises a coverage state of each of N carriers.

11. The method of claim 9, wherein the CA configuration information comprises a resource mode for each of N carriers.

12. The method of claim 9, wherein the CA configuration information includes two mapping rules between services and carriers.

13. The method of claim 12, wherein one of the mapping rules is mandatory and the other mapping rule is optional.

14. An apparatus for wireless communication comprising one or more processors, configured to cause the apparatus to:
receive, by a first user device, a carrier aggregation (CA) operation information, wherein the first user device is configured to perform a device-to-device communication using CA with a second user device without relaying through a network device; and
operate the first user device according to the CA operation information.

15. The apparatus of claim 14, wherein the CA operation information comprises CA assistance information that includes a coverage state of each of N carriers.

16. The apparatus of claim 14, wherein the CA operation information includes CA assistance information that comprises a resource mode for each of N carriers.

17. The apparatus of claim 14, wherein the CA operation information comprises CA configuration information that includes one or more mapping rules between services and carriers.

18. An apparatus for wireless communication comprising one or more processors, configured to cause the apparatus to:
transmit, by a wireless device to a first user device, a carrier aggregation (CA) configuration information, wherein the first user device is configured to perform a device-to-device communication using CA with a second user device without relaying through a network device.

19. The apparatus of claim 18, wherein the CA configuration information comprises a coverage state of each of N carriers.

20. The apparatus of claim 18, wherein the CA configuration information comprises a resource mode for each of N carriers.
